(19) United States
(12) Patent Application Publication
(10) Pub. No.: US 2012/0303525 A1
(43) Pub. Date: Nov. 29, 2012

(54) METHODS AND SYSTEMS FOR VERIFYING REGULATION COMPLIANCE

(76) Inventor: Sharath Sahadevan, St. Charles, MO (US)

(21) Appl. No.: 13/113,865

(22) Filed: May 23, 2011

(51) Int. Cl. G06Q 40/00; G06F 17/30

(52) U.S. Cl. 705/44; 707/703; 707/E17.007

(57) ABSTRACT

A computer and a computer-based method for verifying compliance of transaction data for a chargeback transaction with a set of regulations is provided. The method includes storing transaction data and a plurality of regulation sets wherein each regulation set is associated with a reason code and defines compliance of a chargeback transaction with the associated reason code, and receiving a chargeback message for the chargeback transaction wherein the chargeback message includes an assigned reason code for requesting the chargeback transaction and a transaction identifier for identifying transaction data associated with the chargeback transaction. The method further includes retrieving transaction data based on the transaction identifier, retrieving a regulation set wherein the retrieved regulation set is associated with the assigned reason code included within the received chargeback message, and verifying the assigned reason code assigned to the chargeback transaction by comparing the retrieved transaction data to the retrieved regulation set.

### BACKGROUND OF THE INVENTION

The embodiments described herein relate generally to methods and systems for verifying regulation compliance and, more particularly, to network-based methods and systems for verifying compliance of transaction data for a chargeback transaction with a set of regulations associated with an assigned reason code for processing the chargeback transaction.

Individuals and businesses are oftentimes required to comply with numerous regulations in today's society. For example, there are regulations that govern financial disputes such as in the credit card industry that individuals and businesses must comply with. There are also regulations that are directed to improving security and/or financial reform such as the Patriot Act, and the Dodd-Frank Act. There are also organizations that promulgate regulations that are directed to improving financial security such as the Office of Foreign Assets Control (OFAC).

With respect to the credit card industry, a dispute process has been created wherein cardholders can dispute charges assigned to their accounts by merchants for a variety of reasons. The credit card dispute process, which was created many years ago, has seen many changes leading to a more complex system that is difficult to learn. Today, it typically takes a chargeback analyst twelve (12) months to become proficient in a job that statistics show they will leave generally within eighteen (18) months. In many companies, being a chargeback analyst is an entry-level position which requires an extensive knowledge in a number of areas including, for example, forty-four (44) U.S. chargeback reason codes, forty (40) international chargeback reason codes, differences between T&E and non-T&E disputes, differences between card present and card-not-present disputes and possible pre-compliance situations.

Each of these chargeback reason codes has a set of regulations or requirements assigned to it. These regulations are defined by a regulating entity such as the interchange network used for processing these card-based transactions. These regulations can be very complicated to understand and to apply to a particular chargeback request.

In other words, when a chargeback request is received by a chargeback analyst, who is typically associated with an issuing bank, from a cardholder, the analyst must decide which reason code should apply to this particular chargeback request. To do so, the analyst must consider the transaction data (e.g., purchase date, purchase amount, card present or card-not-present, etc.) associated with this chargeback request and the regulations associated with each reason code. Once the analyst determines the proper reason code to be assigned to the chargeback request, the analyst submits the chargeback request with the assigned reason code for further processing.

Unfortunately, in some cases, the analyst may assign an improper reason code to the chargeback request. An improperly assigned reason code results in a rejected chargeback request, which delays the processing of the chargeback, and results in additional costs for all parties involved. In addition, it may result in the delay of a legitimate refund for the cardholder.

In addition, reason code regulations oftentimes are changed by the regulating entity. When these changes occur, the regulating entity must provide these changes to each of its customers (i.e., the regulated entities) so that the customers can upload the changes into their systems for future use. Failure to upload these changes in a timely fashion typically results in more rejections of chargeback requests due to improperly assigned reason codes.

Accordingly, it would be desirable to provide a method and system that is capable of receiving (i) data, (ii) a regulation identifier, and (iii) a set of regulations associated with the regulation identifier, and verifying that the data complies with the set of regulations. More specifically, it would be desirable to provide a method and system that is capable of receiving transaction data for a chargeback transaction along with a reason code assigned to a set of regulations, and verifying that the chargeback transaction data complies with the set of regulations so that the assigned reason code is verified before it is submitted to the chargeback processing system.

### BRIEF DESCRIPTION OF THE INVENTION

In one aspect, a computer-based method for verifying compliance of transaction data for a chargeback transaction with a set of regulations is provided. The method uses a computer device coupled to a database. The method includes storing within the database transaction data and a plurality of sets of regulations wherein each regulation set is associated with a reason code and each regulation set defines compliance of a chargeback transaction with the associated reason code, and receiving at the computer device a chargeback message for the chargeback transaction wherein the chargeback message includes an assigned reason code for requesting the chargeback transaction and a transaction identifier for identifying transaction data associated with the chargeback transaction. The method further includes retrieving transaction data from the database based on the transaction identifier, retrieving a regulation set of the plurality of regulation sets stored within the database wherein the retrieved regulation set is associated with the assigned reason code included within the received chargeback message, and verifying the assigned reason code assigned to the chargeback transaction by comparing the retrieved transaction data to the retrieved regulation set.

In another aspect, a computer system for verifying compliance of transaction data for a chargeback transaction with a set of regulations is provided. The computer system includes a memory device, and a compliance computer device comprising a processor that is in communication with the memory device. The memory device is used to store transaction data and a plurality of sets of regulations wherein each regulation set is associated with a reason code and defines compliance of a chargeback transaction with the associated reason code. The compliance computer system is programmed to receive a chargeback message for the chargeback transaction wherein the chargeback message includes an assigned reason code for requesting the chargeback transaction and a transaction identifier for identifying transaction data associated with the chargeback transaction, retrieve transaction data from the memory device based on the transaction identifier, retrieve a regulation set of the plurality of regulation sets stored within the memory device wherein the retrieved regulation set is associated with the assigned reason code included within the received chargeback message, and verify the assigned reason code assigned to the chargeback transaction by comparing the retrieved transaction data to the retrieved regulation set.

In yet another aspect, one or more computer-readable non-transitory media comprising a computer-executable program that instructs at least one processor to verify compliance of transaction data for a chargeback transaction with a set of regulations is provided. The computer-executable program includes at least one code segment that instructs the at least one processor to store transaction data and a plurality of sets of regulations within a memory device wherein each regulation set is stored with an associated reason code and defines compliance of a chargeback transaction with the associated reason code, receive a chargeback message for the chargeback transaction including an assigned reason code for requesting the chargeback transaction and a transaction identifier for identifying transaction data associated with the chargeback transaction, retrieve transaction data from the memory device based on the transaction identifier, retrieve a regulation set of the plurality of regulation sets stored within the memory device wherein the retrieved regulation set is associated with the assigned reason code included within the received chargeback message, and verify the assigned reason code assigned to the chargeback transaction by applying the retrieved transaction data to the retrieved regulation set.

In yet another aspect, a computer-based method for verifying compliance of compliance data with a selected regulation type is provided. The method uses a computer device coupled to a database. The method includes storing compliance data and a plurality of regulation types within the database wherein each regulation type includes a set of regulations and a regulation identifier, and wherein each regulation set defines compliance with the regulation type associated therewith. The method further includes receiving at the computer device a request message including an assigned regulation identifier and a compliance data identifier wherein the assigned regulation identifier identifies the selected regulation type, retrieving compliance data from the database based on the compliance data identifier, retrieving a regulation set of the plurality of regulation sets stored within the database wherein the retrieved regulation set is associated with the assigned regulation identifier included within the received request message, and verifying the retrieved compliance data complies with the selected regulation type by comparing the retrieved compliance data to the retrieved regulation set.

### BRIEF DESCRIPTION OF THE DRAWINGS

FIGS. 1-7 show exemplary embodiments of the systems and methods described herein.

FIG. 1 is a schematic diagram illustrating an exemplary multi-party payment card industry system for enabling ordinary payment-by-card transactions in which merchants and card issuers do not necessarily have a one-to-one relationship.

FIG. 2 is a simplified block diagram of an exemplary regulation compliance system in accordance with one embodiment of the present invention.

FIG. 3 is an expanded block diagram of an exemplary embodiment of a server architecture of a regulation compliance system in accordance with one embodiment of the present invention.

FIG. 4 illustrates an exemplary configuration of a client system shown in FIGS. 2 and 3.

FIG. 5 illustrates an exemplary configuration of a server system shown in FIGS. 2 and 3.

FIG. 6 is a schematic data flow diagram of the exemplary regulation compliance system shown in FIGS. 2 and 3 being used as a chargeback compliance system for validating reason codes.

FIG. 7 is a schematic data flow diagram of an exemplary multiple regulation compliance system for verifying compliance with a set of regulations included within a plurality of regulation types.

### DETAILED DESCRIPTION OF THE INVENTION

The embodiments described herein facilitate verifying compliance of certain data with a set of regulations assigned to a particular regulation identifier. More specifically, the embodiments described herein facilitate verifying compliance of transaction data for a chargeback transaction with a set of regulations assigned to a specific reason code. Once verified, the chargeback transaction can be further processed using the verified reason code.

In the example embodiment, a regulation compliance system that is used for processing chargeback transactions, and thus, sometimes referred to as a chargeback compliance system, includes a transaction card system (also referred to as a financial transaction payment system) coupled to a chargeback compliance computer device. The transaction card system is used for processing and storing transaction data of users. The chargeback compliance computer device is used for determining whether a reason code that is assigned to a particular chargeback transaction complies with the regulations associated with that particular reason code.

The methods and systems described herein may be implemented using computer programming or engineering techniques including computer software, firmware, hardware or any combination or subset thereof, wherein the technical effect may include at least one of: (a) charging a transaction to an account associated with a cardholder and a cardholder transaction card, wherein the transaction card is issued to the cardholder by an issuer and the transaction is associated with a merchant; (b) transmitting a chargeback request from the cardholder to the issuer requesting a chargeback for at least a portion of the transaction, wherein the chargeback request includes a reason for requesting the chargeback for the chargeback transaction; (c) transmitting a chargeback message from the issuer for the chargeback transaction identified in the chargeback request, wherein the chargeback message includes an assigned reason code for the chargeback and a transaction identifier for identifying the chargeback transaction; (d) retrieving transaction data from a database based on the transaction identifier included within the received chargeback message, wherein the transaction data relates to or represents the chargeback transaction; (e) retrieving from the database a set of regulations associated with the assigned reason code, the set of regulations defines compliance of the chargeback transaction with the assigned reason code; (f) applying the transaction data of the chargeback transaction to the retrieved set of regulations to determine compliance of the chargeback transaction with the assigned reason code; (g) verifying the assigned reason code if the transaction data of the chargeback transaction complies with the retrieved set of regulations; (h) transmitting the verified chargeback message to the merchant or acquiring bank for further processing; and (i) transmitting an error message to the issuer if the assigned reason code is not verified, wherein the error message includes one or more regulations from the retrieved set of regulations that the transaction data failed to comply with.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of transaction card can be used as a method of payment for performing a transaction.

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of AT&T located in New York, N.Y.). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications. As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

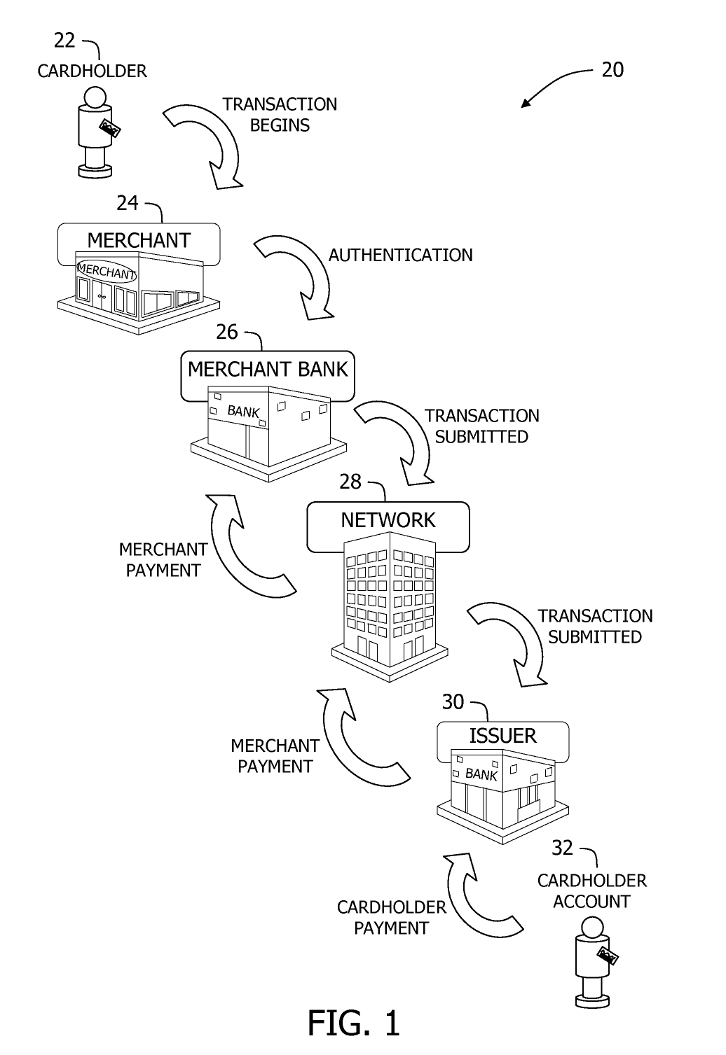

FIG. 1 is a schematic diagram illustrating an exemplary multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.)

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's account 32 is in good standing and whether the purchase is covered by cardholder's 22 available credit line. Based on these determinations, the request for authorization will be declined or accepted. If the request is accepted, an authorization code is issued to merchant 24.

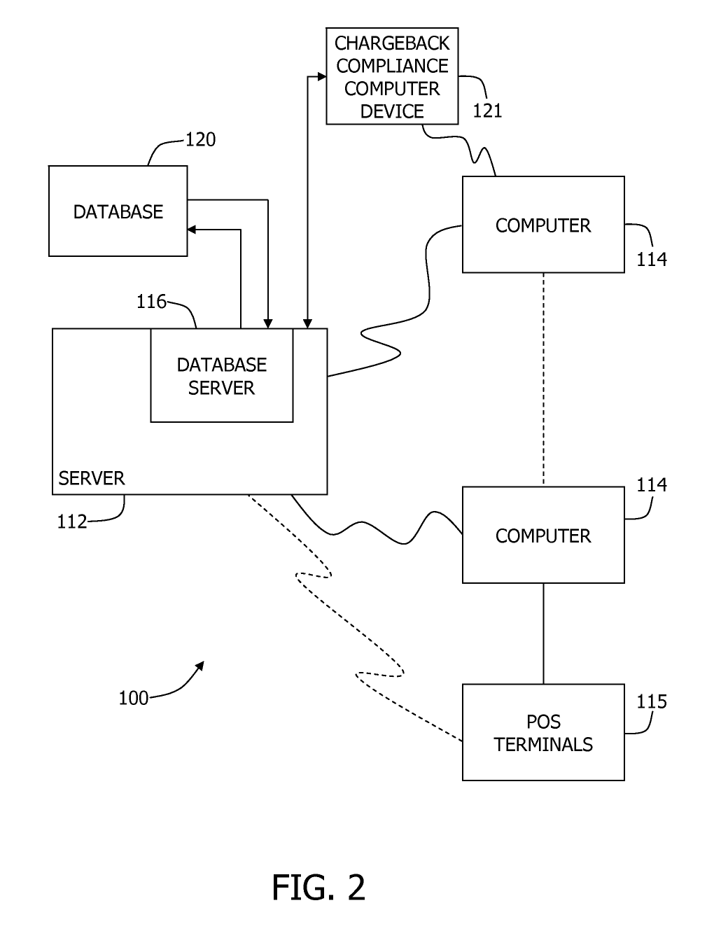

When a request for authorization is accepted, the available credit line of cardholder's account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a data warehouse 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction.

As used herein, the term “transaction data” refers to data that includes at least a portion of a cardholder's account information (i.e., cardholder name, account number, credit line, security code, and/or expiration data) and at least a portion of purchase information (i.e., price, a type of item and/or service, SKU number, item/service description, purchase date, and/or confirmation number) supplied by a merchant from which the cardholder is making a purchase.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an exemplary regulation compliance system 100 for verifying compliance with a regulation in accordance with one embodiment of the present invention. In the example embodiment, regulation compliance system 100 is a chargeback compliance system for verifying reason codes included with a chargeback message submitted with respect to a financial transaction associated with a cardholder.

In the example embodiment, system 100 may be used to implement multi-party transaction card industry system 20 (shown in FIG. 1). In one embodiment, system 100 includes a transaction card system (also referred to as a financial transaction payment system) coupled to a chargeback compliance computer device. The transaction card system is used for processing and storing transaction data of users. The chargeback compliance computer device is used to determine whether a reason code that is assigned to a particular chargeback transaction complies with the requirements associated with that particular reason code, whether additional information is needed to determine whether compliance is achieved, or whether another reason code is recommended. The chargeback relates to a dispute lodged by a user with respect to at least one transaction assigned to an account associated with a cardholder.

More specifically, compliance system 100 includes a transaction card system coupled to a chargeback compliance computer device wherein system 100 is configured to store compliance requirements/regulations for each reason code processed by the system, process a transaction initiated by a cardholder using a transaction card, receive a chargeback message for the transaction processed by the transaction card system that includes a reason code for the chargeback, and determine whether the chargeback transaction data complies with the compliance requirements for the received reason code.

In the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 115, which are connected to client systems 114 and may be connected to server system 112. POS terminals 115 are interconnected to the Internet through many interfaces including a network, such as a LAN or a WAN, dial-in-connections, cable modems, wireless modems, and special high-speed ISDN lines. POS terminals 115 could be any device capable of interconnecting to the Internet and including an input device capable of reading information regarding a cardholder's financial transaction card.

A database server 116 is connected to a database 120, which includes information on a variety of matters, as described below in greater detail. Database 120 is also referred to herein as a “data warehouse”. In one embodiment, centralized database 120 is stored on server system 112 and can be accessed by potential users at one of client systems 114 by logging onto server system 112 through one of client systems 114. In an alternative embodiment, database 120 is stored remotely from server system 112 and/or may be non-centralized.

Database 120 may store information related to cardholders and/or transaction data generated as part of sales activities conducted over interchange network 28, including data relating to merchants, account holders or consumers, purchases, a name of a cardholder, an account number, a transaction history, and other cardholder-related information. For example, database 120 may store data relating to a list of cardholders participating in programs with interchange network 28 (shown in FIG. 1); merchant identifiers; product codes; transaction terms; financing data; interchange rate data for different types of transactions performed over the interchange network; rewards program data for different rewards programs offered by the issuer or the interchange network; and/or any data related to operation of system 100. Database 120 may also store reason codes; other regulations relating to finances, healthcare, security, etc.; and requirements associated with each reason code or regulations for compliance. Database 120 may include a single database having separated sections or partitions or may include multiple databases, each being separate from each other.

In the example embodiment, one of client systems 114 may be associated with acquirer bank 26 (shown in FIG. 1) while another one of client systems 114 may be associated with issuer bank 30 (shown in FIG. 1). POS terminal 115 may be associated with a participating merchant 24 (shown in FIG. 1) or may be a computer system and/or mobile system used by a cardholder making an on-line purchase or payment. Server system 112 may be associated with interchange network 28. In the exemplary embodiment, server system 112 is associated with a network interchange, such as interchange network 28, and may be referred to as an interchange computer system. Server system 112 may be used for processing transaction data. In addition, client systems 114 and/or POS terminal 115 may include a computer system associated with at least one of an online bank, a bill payment outsourcer, an acquirer bank, an acquirer processor, an issuer bank associated with a transaction card, an issuer processor, a remote payment system, and/or a biller. Accordingly, each party involved in processing transaction data are associated with a computer system shown in system 100 such that the parties can communicate with one another as described herein.

In addition, system 100 includes a chargeback compliance computer device 121 coupled to server system 112 and/or to client system 114. Device 121 is configured to receive a chargeback message for a transaction processed by server system 112 wherein the chargeback message includes a reason code and a transaction identifier for the chargeback, and determine whether the chargeback transaction data complies with the compliance regulations for the received reason code. Data associated with the reason codes and the compliance regulations can be stored within database 120 or within a memory device coupled directly to or at device 121.

The embodiments illustrated and described herein as well as embodiments not specifically described herein but within the scope of aspects of the invention constitute exemplary means for verifying compliance with a set of regulations, and more particularly, constitute exemplary means for verifying that transaction data for a chargeback request complies with a set of regulations associated with a reason code assigned to the chargeback request. For example, server system 112, client system 114, chargeback compliance computer device 121 or any other similar computer device, programmed with computer-executable instructions to execute processes and techniques as described herein, constitutes exemplary means for monitoring a price of an item and/or service purchased using a transaction card.

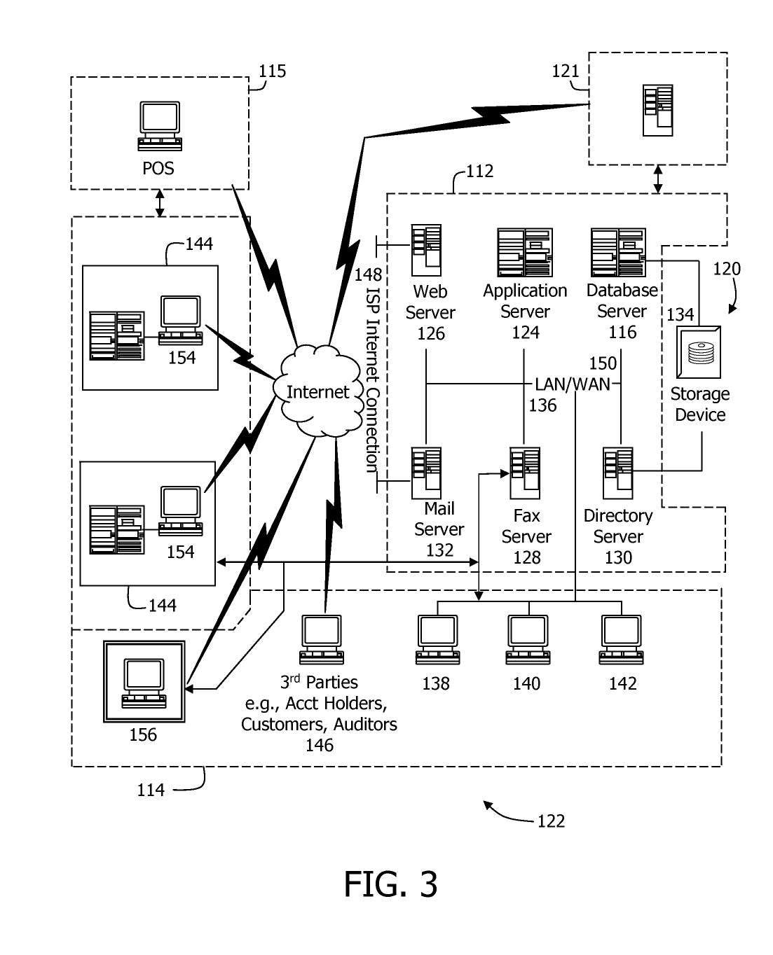

FIG. 3 is an expanded block diagram of an exemplary embodiment of a server architecture of a regulation compliance system 100 for verifying compliance with a regulation or a set of regulations in accordance with one embodiment of the present invention. Components in system 122, identical to components of system 100 (shown in FIG. 2), are identified in FIG. 3 using the same reference numerals as used in FIG. 2. System 122 includes server system 112, client systems 114, and POS terminals 115, and chargeback compliance computer device 121. Server system 112 further includes database server 116, an application server 124, a web server 126, a fax server 128, a directory server 130, and a mail server 132. A storage device 134 is coupled to database server 116 and directory server 130. Storage device 134 is any computer-operated hardware for storing and/or retrieving data. In the exemplary embodiment, database 120 is part of storage device 134. Servers 116, 124, 126, 128, 130, and 132 are coupled in a LAN 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136. In the example embodiment, workstations 138, 140, and 142 may be associated with at least one of an online bank, an acquirer bank, an acquirer processor, an issuer bank associated with a transaction card, an issuer processor, and a merchant.

Server system 112 is configured to be communicatively coupled to various individuals, including employees 144 and to third parties, account holders, customers, auditors, etc., 146 using an ISP Internet connection 148. The communication in the exemplary embodiment is illustrated as being performed using the Internet, however, any other WAN-type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

Chargeback compliance computer device 121 is in communication with server system 112 and in communication with client systems 114 and other workstations through a network connection.

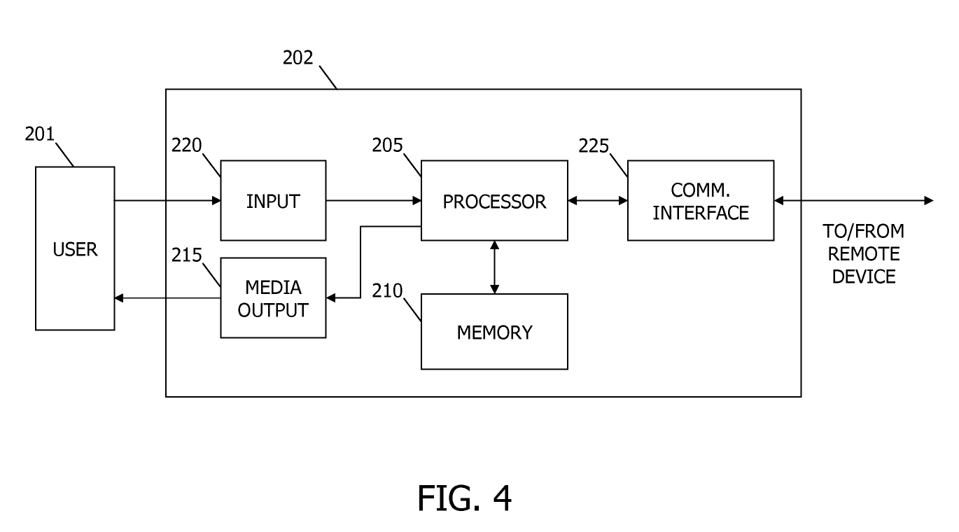

FIG. 4 illustrates an exemplary configuration of a user computing device 202 operated by a user 201, such as cardholder 22 (shown in FIG. 1). User computing device 202 may include, but is not limited to, client systems 114, 138, 140, and 142, POS terminal 115, workstation 154, and manager workstation 156. In the exemplary embodiment, user computing device 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User computing device 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user computing device 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User computing device 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112 or computer device 121. A client application allows user 201 to interact with a server application from server system 112 and/or computer device 121.

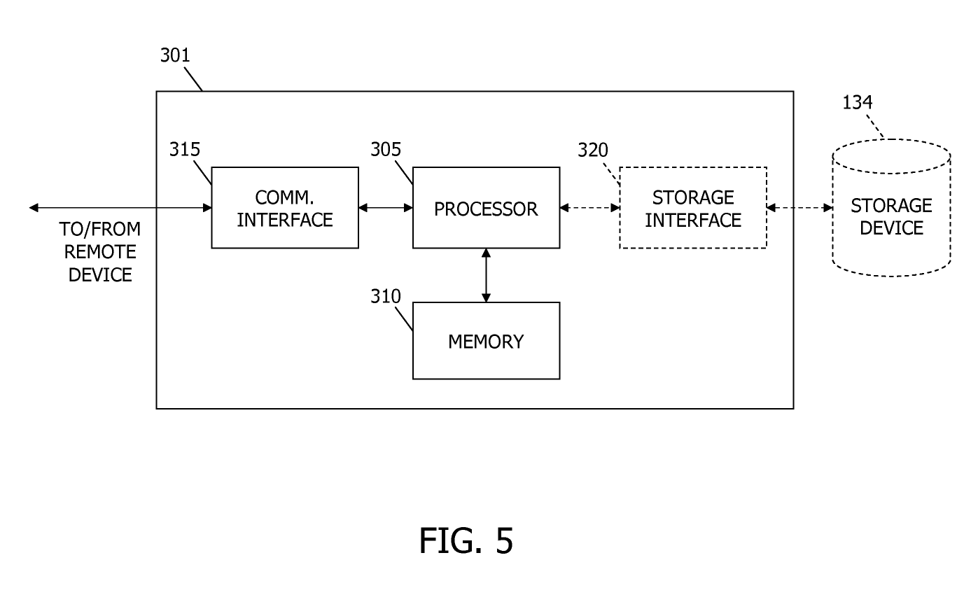

FIG. 5 illustrates an exemplary configuration of a server computing device 301 such as server system 112 and/or computer device 121 (shown in FIG. 2). Server computing device 301 may include, but is not limited to, database server 116, application server 124, web server 126, fax server 128, directory server 130, mail server 132, and computer device 121. Server computing device 301 also includes a processor 305 for executing instructions. Instructions may be stored in a memory area 310, for example. Processor 305 may include one or more processing units, for example, a multi-core configuration. In the exemplary embodiment, processor 305 is operatively coupled to a communication interface 315 such that server computing device 301 is capable of communicating with a remote device such as user computing device 202 or another server computing device 301. For example, communication interface 315 may receive requests from user computing device 114 via the Internet, as illustrated in FIG. 3.

Processor 305 may also be operatively coupled to a storage device 134. Storage device 134 is any computer-operated hardware suitable for storing and/or retrieving data. In some embodiments, storage device 134 is integrated in server computing device 301. For example, server computing device 301 may include one or more hard disk drives as storage device 134. In other embodiments, storage device 134 is external to server computing device 301 and may be accessed by a plurality of server computing devices 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134. Referring to FIGS. 4 and 5, a software application may operate at least in part by exchanging data, such as requests and responses, between user computing device 202 and server computing device 301. For example, a “client side” software component executed by user computing device 202 may request data stored in storage device 134 and/or may initiate a transaction, such as a payment transaction, through server computing device 301.

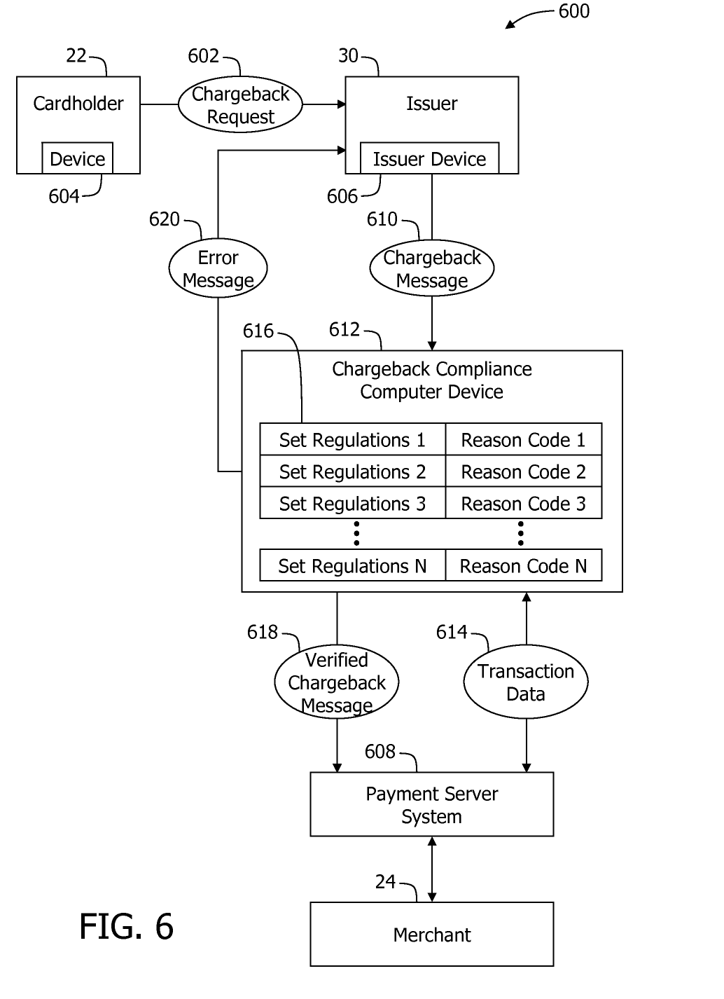

FIG. 6 is a schematic data flow diagram of an exemplary chargeback compliance system 600 for verifying reason codes included within a chargeback message submitted with respect to a financial transaction associated with a cardholder. System 600 is similar to system 100 shown in FIG. 2.

In the example embodiment, the data flow within system 600 includes submitting a chargeback request 602 by a cardholder such as cardholder 22. More specifically, chargeback request 602 is submitted by cardholder 22 to an issuing bank such as issuing bank 30. Chargeback request 602 is submitted by cardholder 22 using a cardholder computer system 604, which is similar to client system 114, to an issuer computer system 606, which is similar to client system 114.

In the example embodiment, chargeback request 602 relates to a transaction (i.e., the chargeback transaction) with merchant 24 that is charged to an account assigned to cardholder 22, wherein cardholder 22 requests that a chargeback be applied. The chargeback transaction would have been initiated using the transaction card issued to cardholder 22 and would have been processed by payment server system 608, which is similar to payment server system 112. Chargeback request 602 includes a reason for requesting the chargeback for the chargeback transaction.

Issuing bank 30 (i.e., the regulated entity) transmits a chargeback message 610 for the chargeback transaction identified in chargeback request 602 sent by cardholder 22. Chargeback message 610 is transmitted from issuer computer system 606 to a chargeback compliance computer device 612, which is similar to computer device 121. Chargeback message 610 includes an assigned reason code for the chargeback and a transaction identifier for identifying the chargeback transaction. The assigned reason code is a reason code that has been assigned to the chargeback request by the issuing bank.

Chargeback compliance computer device 612 retrieves transaction data 614 from database 120 or another memory device based on received chargeback message 610. More specifically, chargeback compliance computer device 612 retrieves transaction data 614 from database 120 or another memory device based on the transaction identifier included within received chargeback message 610. Transaction data 614 relates to or represents the chargeback transaction.

Chargeback compliance computer device 612 retrieves from database 120 or another memory device a set of regulations 616 associated with the assigned reason code. Each reason code stored in the database or memory device has a set of regulations 616 associated therewith. Sets of regulations 616 are defined by the regulating entity (i.e., interchange network/payment network). A set of regulations 616 is assigned to a reason code and is defined to determine whether a particular chargeback transaction complies with the reason code for chargeback. In other words, if transaction data 614 associated with a chargeback transaction complies with a set of regulations 616 for an assigned reason code, then the assigned reason code becomes a verified reason code and can be used for processing the chargeback transaction.

Chargeback compliance computer device 612 applies transaction data 614 for the chargeback transaction to retrieved set of regulations 616 to determine whether the chargeback transaction complies with the assigned reason code. If transaction data 614 complies with retrieved set of regulations 616, then the assigned reason code becomes the verified reason code, and the chargeback message becomes a verified chargeback message 618.

Verified chargeback message 618 is transmitted to merchant 24 for further processing of the chargeback transaction. In one embodiment, verified chargeback message 618 is transmitted from chargeback compliance computer device 612 directly to merchant 24. In another embodiment, verified chargeback message 618 is transmitted from chargeback compliance computer device 612 through payment server system 608 to merchant 24 and/or acquiring bank 26.

In the case where chargeback compliance computer device 612 determines that the chargeback transaction does not comply with the assigned reason code (i.e., transaction data 614 does not comply with the retrieved set of regulations 616), then the assigned reason code is not verified and an error message 620 is returned to issuing bank 30. In the example embodiment, error message 620 includes one or more regulations from retrieved set of regulations 616 that transaction data 614 failed to comply with. By providing error message 620, issuing bank 30 is able to (i) advise cardholder 22 as to why chargeback request 602 was denied, or (ii) determine the proper reason code to be assigned to chargeback request 602.

By providing chargeback compliance computer device 612, which is configured to store and manage chargeback reason codes and sets of regulations 616 associated with the reason codes, any changes to reason code regulations 616 can be easily made and managed by the regulating entity (i.e., interchange network/payment system). For example, if set of regulations 616 associated with Reason Code 4842 (Late Presentment) are changed by the regulating entity, the regulating entity would only need to notify the regulated entity of the change and then upload the changed regulation(s) to chargeback compliance computer device 612. Accordingly, for each chargeback message 610 having an assigned Reason Code 4842 that is submitted to chargeback compliance computer device 612 after the updating of the reason code regulations, the updated set of regulations 616 would be automatically applied to the corresponding transaction data 614 to verify that transaction data 614 complies with the updated set of regulations 616.

In the example embodiment, when a cardholder uses a transaction payment card (e.g., MasterCard® card) to purchase goods or services from a card acceptor, the acquirer will reimburse the card acceptor for the transaction. The acquirer then settles those funds with the issuer by presenting the transaction into interchange. The interchange network (e.g., MasterCard) provides this functionality. In summary, clearing is the movement of data from the acquirer to the interchange network/payment system, and from the interchange network to the issuer. Settlement is the process used to exchange funds between members for the net value of the monetary transactions cleared for that processing day. Interchange is the exchange of transaction data between members.

After the first presentment of a transaction from the acquirer to the issuer, the issuer may determine that, for a given reason, the transaction may be invalid. The issuer may then return the transaction to the acquirer as a chargeback for possible remedy. When an issuer has billed a transaction to its cardholder's account for payment and then chooses to exercise a chargeback right, the issuer must credit the cardholder's account for the amount of the chargeback. Under no circumstances should an issuer ultimately be reimbursed twice for the same transaction. Similarly, an issuer should not credit a cardholder twice because of a chargeback processed by the issuer and a credit voucher processed by the card acceptor.

When the issuer transmits a chargeback message, the issuer is required to provide a message reason code. Chargebacks typically fall into five categories: Authorization; Fraud; Cardholder Disputes; Retrieval Request and Documentation Required; and Errors in Processing or Procedure.

The following message reason codes are authorization-related: Reason Code 4807—Warning Bulletin File; Reason Code 4808—Requested/Required Authorization Not Obtained; and Reason Code 4812—Account Number Not On File.

The following message reason codes are fraud-related: Reason Code 4837—No Cardholder Authorization; Reason Code 4840—Fraudulent Processing of Transactions; Reason Code 4847—Requested/Required Authorization Not Obtained and Fraudulent Transaction; Reason Code 4849—Questionable Merchant Activity; Reason Code 4862—Counterfeit Transaction Magnetic Stripe POS Fraud; Reason Code 4863—Cardholder Does Not Recognize—Potential Fraud; and Reason Code 4870—Chip Liability Shift.

The following message reason codes apply to cardholder disputes: Reason Code 4841—Cancelled Recurring Transaction; Reason Code 4853—Cardholder Dispute—Defective Merchandise/Not as Described; Reason Code 4854—Cardholder Dispute—Not Elsewhere Classified (U.S. region only); Reason Code 4855—Nonreceipt of Merchandise; Reason Code 4857—Card-Activated Telephone Transaction; and Reason Code 4859—Services Not Rendered.

The following message reason codes apply to chargebacks for retrieval request and documentation-related chargebacks: Reason Code 4801—Requested Transaction Data Not Received; Reason Code 4802—Requested/Required Information Illegible or Missing; and Reason Code 4863—(First chargeback only) Cardholder Does Not Recognize—Potential Fraud.

The following message reason codes generally apply to errors in processing or procedure: Reason Code 4831—Transaction Amount Differs; Reason Code 4834—Duplicate Processing; Reason Code 4835—Card Not Valid or Expired; Reason Code 4842—Late Presentment; Reason Code 4846—Correct Transaction Currency Code Not Provided; Reason Code 4850—Credit Posted as Purchase; and Reason Code 4860—Credit Not Processed.

As stated above, each reason code has a set of regulations assigned to it. The transaction data for a chargeback transaction must comply with each regulation included within the set of regulations for that particular reason code in order for the chargeback transaction to be verified. For example, Reason Code 4801—Requested Transaction Data Not Received has a set of regulations that must be complied with in order to use Reason Code 4801.

For example, the set of regulations for Reason Code 4801 are provided below:

The issuer may charge back the amount of the requested item using message Reason Code 4801 if it did not receive an original, substitute draft, or copy of a transaction information document (TID) within 30 calendar days following the Central Site Business Date of the Retrieval Request/1644-603 message. The issuer must submit the chargeback within 60 calendar days of the Central Site retrieval request date.

The issuer may not use this chargeback reason (4801) if: (1) The retrieval request is submitted more than 120 calendar days after the Central Site Business Date of the original transaction or if the issuer received the fulfillment for the Retrieval Request/1644-603 message prior to the chargeback, or (2) The transaction was a properly identified PayPass transaction equal to or less than USD 25, or (3) The transaction was a chip/PIN transaction where the transaction certificate and related data was provided in DE 55 of the First Presentment/1240 message.

For intra-European transactions only, the issuer must submit the chargeback within 120 calendar days of the Central Site Retrieval Request Date. In addition, the issuer must supply documentation that proves the issuer is facing financial loss due to the acquirer's non-fulfillment of the retrieval request.

TABLE 1
Regulation Summary for Reason Code 4801

| | Retrieval | Supporting | |
|---|---|---|---|
| Time Frame | Request | Documents | DE 72 (Data Record) |
| Issuer must wait 30 | Yes | Sometimes | DATE MMDDYY TYPE X |
| calendar days from the | | | CTL NNNNNNNNN |
| Central Site Business | | | Replace .MMDDYY. with the date the issuer |
| Date of the Retrieval | | | submitted the retrieval request |
| Request/1644-603 | | | Replace .X. with one of the following numeric |
| message, and must | | | codes used to identify the type of TID requested by |
| submit the chargeback | | | the issuer: |
| within 60 calendar | | | 1 = Hard copy original document |
| days of the Central Site | | | 2 = Copy or image of original document |
| retrieval request date. | | | 4 = Substitute draft |
| | | | Replace .NNNNNNNNN. with the issuer.s control |
| | | | number. The control number is only used by the |
| | | | issuer. |
| | | | If the issuer receives the item from the acquirer |
| | | | outside of the MasterCom system, and it is |
| | | | insufficient, use the following words: |
| | | | INV DOCXX, |
| | | | Replace .XX. with one of the following codes |
| | | | used to identify the reason the item does not satisfy |
| | | | the retrieval request: |
| | | | 01 = wrong item provided |
| | | | 02 = other (specify in DE 72 [Data Record]) |
| The issuer must wait | Yes | Yes | DATE MMDDYY TYPE X CTL NNNNNNNNN |
| 30 calendar days from | | | (CTL is the issuer.s control number) |
| the Central Site | | | Replace .MDDDYY. with the date of the retrieval |
| Business Date of the | | | request |
| Retrieval | | | Replace .X. with one of the following numeric |
| Request/1644-603 | | | codes used to identify the type of TID request by |
| message, and must | | | the issuer: |
| submit the chargeback | | | 1 = Hard copy original document |
| within 120 calendar | | | 2 = Copy or image of original document |
| days of the Central Site | | | 4 = Substitute draft |
| retrieval request date. | | | If the issuer receives the item from the acquirer |
| | | | outside of the MasterCom system, and it is |
| | | | insufficient, use the following words: |
| | | | INV DOCXX |
| | | | Replace .XX. with one of the following codes used |
| | | | to identify the reason the item does not satisfy the |
| | | | retrieval request: |
| | | | 01 = wrong item provided |
| | | | 02 = other (specify in DE 72 [Data Record]) |

The issuer may use reason code 4801 only when there is a justifiable reason for the cardholder not to pay the charge because the acquirer did not provide the requested item. For example, if a cardholder requested a copy of the transaction information document for his or her records, and neither the cardholder nor issuer incurred a financial loss, the issuer should not initiate this chargeback.

If the documentation that the acquirer provides does not satisfy the requirement for the retrieval request, the issuer must reject the item within 10 calendar days of receipt to Image Review with reject reason code “W.” The issuer may not initiate a chargeback unless it receives a favorable response from Image Review.

If the issuer receives an acquirer's response code of A, B, or C through the system and it determines that the response is invalid, it must reject the item to Image Review within 10 calendar days of receipt.

The issuer must provide documentation to Image Review to support an acquirer's invalid response code. The issuer may not originate a chargeback for this reason unless it receives a favorable response from Image Review.

The issuer has chargeback rights under the following conditions: (1) It receives documentation or a response to a retrieval request outside of the system, and the documentation provided does not satisfy the request or requirement for retrieval request fulfillment. (2) It receives an invalid acquirer's response code of A, B, or C and it can document the response to be invalid. To submit a chargeback under these above conditions, the issuer must provide the following: (a) “INV DOC XX” with the applicable code in the DE 72 (Data Record) of the First Chargeback/1442 message, and (b) Documentation to the acquirer to support that it received an invalid acquirer's response code of A, B, or C.

Second presentments are prohibited unless the acquirer has received and has been granted a hardship variance. For intra-European transactions only, second presentments are also permitted if the issuer failed to supply documentation with the first chargeback to justify its financial loss.

An arbitration chargeback does not apply for this message reason code (4801), unless the issuer receives a second presentment from a member that has requested and been granted a hardship variance, but still does not receive the requested item. In this case, the issuer would process an Arbitration Chargeback/1442 message using message reason code 4901.

Each of the reason codes has a set of regulations assigned thereto which must be complied with in order for the reason code to be used with a chargeback transaction. The regulations for Reason Code 4801 are set forth above for exemplary purposes. Other reason codes have similar sets of regulations that must be complied with. However, for the purposes of this application, any set of regulations can be used for any reason code or other regulation identifier. The chargeback compliance computer device is configured to store multiple types of regulations with a corresponding regulation identifier, and determine whether certain data complies with the set of regulations for an assigned regulation identifier. If so, the certain data is verified as being in compliance.

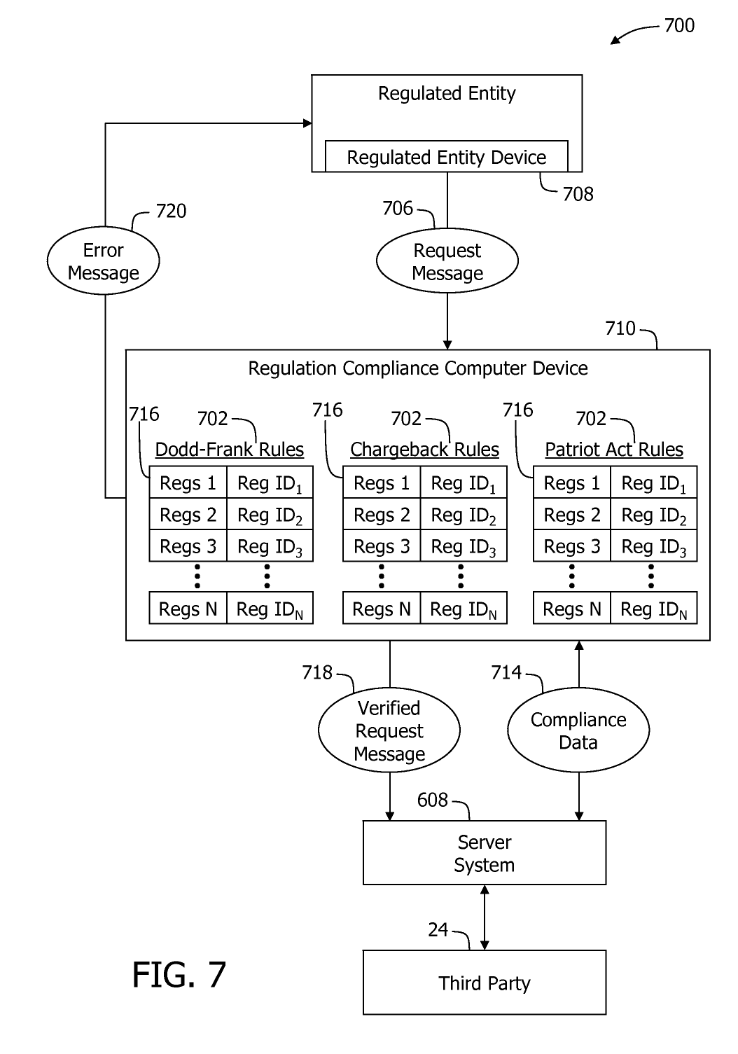

FIG. 7 is a schematic data flow diagram of an exemplary multiple regulation compliance system 700 for verifying compliance with a set of regulations included within a plurality of regulation types. System 700 is similar to system 100 shown in FIG. 2 except system 700 includes multiple regulations types 702.

Data flow within system 700 includes submitting a regulation request message 706 by or on behalf of a regulated entity using a regulated entity computer device 708 to a regulation compliance computer device 710 which is associated with a regulating entity. In the example embodiment, request message 706 can relate to a plurality of regulation types 702 such as Chargeback and Resolution Rules for credit card transactions, Dodd-Frank Wall Street Reform and Consumer Protection Act Rules (full title: “An Act to promote the financial stability of the United States by improving accountability and transparency in the financial system, to end “too big to fail”, to protect the American taxpayer by ending bailouts, to protect consumers from abusive financial services practices, and for other purposes”), and USA Patriot Act Rules (full title: “Uniting and Strengthening America by Providing Appropriate Tools Required to Intercept and Obstruct Terrorism Act of 2001”), etc. Request message 706 includes an assigned regulation identifier and a compliance data identifier for identifying data for verifying compliance. The assigned regulation identifier is assigned by the regulated entity and included within request message 706. Request message 706 is basically a request to verify that certain identified compliance data complies with an identified set of regulations.

Regulation compliance computer device 710 retrieves compliance data 714 from database 120 or another memory device based on received request message 706. More specifically, device 710 retrieves compliance data 714 from database 120 or another memory device based on the compliance data identifier included within received request message 706. Compliance data 714 relates to or represents data used for verifying compliance with a regulation.

Device 710 retrieves from database 120 or another memory device a set of regulations 716 associated with the assigned regulation identifier. Each regulation identifier stored in the database or memory device has a set of regulations 716 associated therewith. Sets of regulations 716 are defined by the regulating entity. A set of regulations 716 is assigned to a regulation identifier and is defined to determine whether certain compliance data complies with the set of regulations associated with that regulation identifier. In other words, if compliance data 714, which is associated with a request message, complies with a set of regulations 716 for an assigned regulation identifier, then the request message becomes a verified request message 718 indicating that the compliance data is in compliance with the set of regulations.

Regulation compliance computer device 710 applies compliance data 714 identified in request message 706 to retrieved set of regulations 716 to determine whether the compliance data 714 complies with the regulations. If compliance data 714 complies with retrieved set of regulations 716, then the request message 706 becomes the verified request message 718 confirming compliance with the regulations. Verified request message 718 is then transmitted to a third party for further processing. In the case where compliance is not verified, an error message 720 is returned to the regulated entity.

Exemplary embodiments of methods and systems for verifying compliance with a set of regulations are described above in detail. The methods and systems are not limited to the specific embodiments described herein, but rather, components of systems and/or steps of the methods may be utilized independently and separately from other components and/or steps described herein. For example, the methods may also be used in combination with other account systems and methods, and are not limited to practice with only the transaction card account systems and methods as described herein. Rather, the exemplary embodiment can be implemented and utilized in connection with many other data storage and analysis applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-based method for verifying compliance of transaction data for a chargeback transaction with a set of regulations using a computer device coupled to a database, said method comprising:
storing within the database transaction data and a plurality of sets of regulations, each regulation set associated with a reason code, each regulation set defining compliance of a chargeback transaction with the associated reason code;
receiving at the computer device a chargeback message for the chargeback transaction, the chargeback message including an assigned reason code for requesting the chargeback transaction and a transaction identifier for identifying transaction data associated with the chargeback transaction;
retrieving transaction data from the database based on the transaction identifier;
retrieving a regulation set of the plurality of regulation sets stored within the database, the retrieved regulation set associated with the assigned reason code included within the received chargeback message; and
verifying the assigned reason code assigned to the chargeback transaction by comparing the retrieved transaction data to the retrieved regulation set.

2. A computer-based method in accordance with claim 1 further comprising processing a transaction initiated by a cardholder with a merchant using a transaction card, wherein the transaction card is issued to the cardholder by an issuer.

3. A computer-based method in accordance with claim 2, wherein receiving a chargeback message further comprises:
receiving the chargeback message from the issuer after the issuer receives a chargeback request from the cardholder, the chargeback request including a request of a credit for at least a portion of the transaction.

4. A computer-based method in accordance with claim 2, wherein receiving a chargeback message further comprises:
receiving the chargeback message for the chargeback transaction, the chargeback message including the assigned reason code, wherein the assigned reason code is assigned to the chargeback transaction on behalf of the issuer.

5. A computer-based method in accordance with claim 1, wherein the computer device is associated with an interchange network used for processing transactions involving transaction cards assigned to cardholders, and the database stores transaction data associated with the processed transactions, and wherein retrieving transaction data further comprises:
identifying transaction data stored within the database based on the transaction identifier included within the received chargeback message, wherein the transaction data represents the chargeback transaction; and
retrieving the identified transaction data to verify compliance of the chargeback transaction with the regulation set associated with the assigned reason code.

6. A computer-based method in accordance with claim 1, wherein retrieving a regulation set further comprises:
retrieving a regulation set of the plurality of regulation sets stored within the database, the retrieved regulation set including a plurality of regulations associated with the assigned reason code, each regulation included within the plurality of regulations defining compliance with the assigned reason code.

7. A computer-based method in accordance with claim 6, wherein verifying the assigned reason code further comprises:
comparing the retrieved transaction data of the chargeback transaction to each regulation included within the retrieved regulation set;
verifying the assigned reason code is properly assigned to the chargeback transaction when the retrieved transaction data of the chargeback transaction satisfies each regulation included within the retrieved regulation set; and
transmitting a verified chargeback message after the assigned reason code is verified.

8. A computer-based method in accordance with claim 1 further comprising:
transmitting an error message when the assigned reason code is not verified as being properly assigned to the chargeback transaction, wherein the error message includes one or more regulations from the retrieved regulation set that the retrieved transaction data failed to comply with.

9. A computer system for verifying compliance of transaction data for a chargeback transaction with a set of regulations, the computer system comprising:
a memory device for storing transaction data and a plurality of sets of regulations, each regulation set associated with a reason code, each regulation set defining compliance of a chargeback transaction with the associated reason code; and
a compliance computer device comprising a processor, the compliance computer system in communication with the memory device, the compliance computer system programmed to:
receive a chargeback message for the chargeback transaction, the chargeback message including an assigned reason code for requesting the chargeback transaction and a transaction identifier for identifying transaction data associated with the chargeback transaction;
retrieve transaction data from the memory device based on the transaction identifier;
retrieve a regulation set of the plurality of regulation sets stored within the memory device, the retrieved regulation set associated with the assigned reason code included within the received chargeback message; and
verify the assigned reason code assigned to the chargeback transaction by comparing the retrieved transaction data to the retrieved regulation set.

10. A computer system in accordance with claim 9, wherein the compliance computer device is further programmed to:
process a transaction involving a transaction card, a cardholder and a merchant, wherein the transaction card is issued to the cardholder by an issuer and is associated with an account assigned to the cardholder; and
store transaction data representing the processed transaction in the memory device.

11. A computer system in accordance with claim 10, wherein the compliance computer device is further programmed to:
receive the chargeback message from the issuer after the issuer receives a chargeback request from the cardholder, the chargeback request including a request of a credit for at least a portion of the transaction.

12. A computer system in accordance with claim 10, wherein the compliance computer device is further programmed to:
receive the chargeback message for the chargeback transaction, the chargeback message including the assigned reason code, the assigned reason code assigned to the chargeback transaction on behalf of the issuer.

13. A computer system in accordance with claim 9, wherein the compliance computer device is associated with an interchange network used for processing transactions involving transaction cards assigned to cardholders, and the memory device stores transaction data associated with the processed transactions, and wherein the compliance computer device is further programmed to:
identify transaction data stored within the memory device based on the transaction identifier included within the received chargeback message, wherein the transaction data represents the chargeback transaction; and
retrieve the identified transaction data to verify compliance of the chargeback transaction with the regulation set associated with the assigned reason code.

14. A computer system in accordance with claim 9, wherein the compliance computer device is further programmed to:
retrieve a regulation set of the plurality of regulation sets stored within the memory device, the retrieved regulation set including a plurality of regulations associated with the assigned reason code, each regulation included within the plurality of regulations defining compliance with the assigned reason code.

15. A computer system in accordance with claim 14, wherein the compliance computer device is further programmed to:
apply the retrieved transaction data of the chargeback transaction to each regulation included within the retrieved regulation set;
verify the assigned reason code is properly assigned to the chargeback transaction when the retrieved transaction data of the chargeback transaction satisfies each regulation included within the retrieved regulation set; and
transmit a verified chargeback message after the assigned reason code is verified.

16. A computer system in accordance with claim 9, wherein the compliance computer device is further programmed to:
transmit an error message when the assigned reason code is not verified as being properly assigned to the chargeback transaction, wherein the error message includes one or more regulations from the retrieved regulation set that the retrieved transaction data failed to comply with.

17. One or more computer-readable non-transitory media comprising a computer-executable program that instructs at least one processor to verify compliance of transaction data for a chargeback transaction with a set of regulations, said computer-executable program comprising at least one code segment that instructs the at least one processor to:
store transaction data and a plurality of sets of regulations within a memory device, each regulation set stored with an associated reason code, each regulation set defining compliance of a chargeback transaction with the associated reason code;
receive a chargeback message for the chargeback transaction, the chargeback message including an assigned reason code for requesting the chargeback transaction and a transaction identifier for identifying transaction data associated with the chargeback transaction;
retrieve transaction data from the memory device based on the transaction identifier;
retrieve a regulation set of the plurality of regulation sets stored within the memory device, the retrieved regulation set associated with the assigned reason code included within the received chargeback message; and
verify the assigned reason code assigned to the chargeback transaction by applying the retrieved transaction data to the retrieved regulation set.

18. One or more computer-readable non-transitory media in accordance with claim 17, wherein the at least one code segment further instructs the at least one processor to:
process a transaction initiated by a cardholder using a transaction card with a merchant, wherein the transaction card is issued to the cardholder by an issuer;
store transaction data representing the processed transaction within the memory device; and
receive the chargeback message from the issuer after the issuer receives a chargeback request from the cardholder, the chargeback request including a request of a credit for at least a portion of the transaction.

19. One or more computer-readable non-transitory media in accordance with claim 17, wherein the at least one code segment further instructs the at least one processor to:
process a transaction initiated by a cardholder using a transaction card with a merchant, wherein the transaction card is issued to the cardholder by an issuer;
store transaction data representing the processed transaction within the memory device;
identify transaction data stored within the memory device based on the transaction identifier included within the received chargeback message, wherein the transaction data represents the chargeback transaction; and
retrieve the identified transaction data to verify compliance of the chargeback transaction with the regulation set associated with the assigned reason code.

20. One or more computer-readable non-transitory media in accordance with claim 17, wherein the at least one code segment further instructs the at least one processor to:
retrieve a regulation set of the plurality of regulation sets stored within the memory device, the retrieved regulation set including a plurality of regulations associated with the assigned reason code, each regulation included within the plurality of regulations defining compliance with the assigned reason code;
apply the retrieved transaction data of the chargeback transaction to each regulation included within the retrieved regulation set;
verify the assigned reason code is properly assigned to the chargeback transaction when the retrieved transaction data of the chargeback transaction satisfies each regulation included within the retrieved regulation set; and
transmit a verified chargeback message after the assigned reason code is verified.

21. One or more computer-readable non-transitory media in accordance with claim 17, wherein the at least one code segment further instructs the at least one processor to:
transmit an error message when the assigned reason code is not verified as being properly assigned to the chargeback transaction, wherein the error message includes one or more regulations from the retrieved regulation set that the retrieved transaction data failed to comply with.

22. A computer-based method for verifying compliance of compliance data with a selected regulation type using a computer device coupled to a database, said method comprising:
storing compliance data and a plurality of regulation types within the database, each regulation type including a set of regulations and a regulation identifier, each regulation set defining compliance with the regulation type associated therewith;
receiving at the computer device a request message including an assigned regulation identifier and a compliance data identifier, wherein the assigned regulation identifier identifies the selected regulation type;
retrieving compliance data from the database based on the compliance data identifier;
retrieving a regulation set of the plurality of regulation sets stored within the database, the retrieved regulation set associated with the assigned regulation identifier included within the received request message; and
verifying the retrieved compliance data complies with the selected regulation type by comparing the retrieved compliance data to the retrieved regulation set.

23. A computer-based method in accordance with claim 22, wherein the plurality of regulation types includes at least chargeback and resolution rules for credit card transactions, Dodd-Frank Wall Street Reform and Consumer Protection Act rules, and USA Patriot Act rules.
